(19) United States
(12) Patent Application Publication
(10) Pub. No.: US 2026/0135071 A1
(43) Pub. Date: May 14, 2026

(54) ION PUMP WITH A MONITORING SYSTEM AND METHOD FOR OPERATING THE ION PUMP

(71) Applicant: Agilent Technologies, Inc, Santa Clara, CA (US)

(72) Inventors: Tiziano Isoardi, Torino (IT); Paolo Manassero, Torino (IT); Luca Bonmassar, Torino (IT); Sara Drovandi, Torino (IT)

(21) Appl. No.: 19/388,260

(22) Filed: Nov. 13, 2025

(30) Foreign Application Priority Data
Nov. 13, 2024 (EP) 24212738.9

(51) Int. Cl. H01J 41/12; G01K 13/00

(52) U.S. Cl. CPC H01J 41/12; G01K 13/00

(57) ABSTRACT

An ion pump is equipped with a monitoring system that, by monitoring the temperature present inside the ion pump, makes it possible to determine whether the ion pump is in an OFF state or an ON state while an electric potential difference is being applied between the pump electrodes. The monitoring system further makes it possible to assess the ON state or OFF state of the ion pump even when the ion pump is operating under low-pressure conditions, with an electric current below the minimum value detectable by conventional reading scales. A method for operating the ion pump utilizes the monitoring system to assess the ON/OFF state of the ion pump while an electric potential difference is being applied between the pump electrodes.

### CROSS-REFERENCE TO RELATED APPLICATIONS

The present application claims the benefit of European Patent Application No. EP 24212738.9, filed on Nov. 13, 2024, which is incorporated herein by reference in its entirety.

### TECHNICAL FIELD

The present disclosure relates to an ion pump used for creating a vacuum. More particularly, the present disclosure relates to an ion pump equipped with a monitoring system allowing determining whether the ion pump is in operation. By way of non-limiting example, the ion pump can be a low-pressure ion pump. The present disclosure further relates to a method of operating an ion pump employing the monitoring system.

### BACKGROUND

An ion pump is a device able to create and maintain high-vacuum conditions within an environment. The ion pump operation is based on one or more Penning cells, which, as described in more detail below, use a combination of electric and magnetic fields to confine electrons and start ionization and getter pumping processes.

A conventional ion pump 1, shown in FIG. 1, comprises a vacuum casing 2 which accommodates:
at least one anode 3, consisting of a plurality of hollow cylindrical pumping cells 4; and
at least one cathode 5, consisting of plates 5a, 5b, for example made of titanium, located at the opposite ends of the cells 4.

The ion pump 1 further comprises a device (e.g., voltage source) 6, suitable for applying to the anode 3 an electric potential higher than the electric potential at the cathode 5, and magnets 7 placed outside the casing 2, at the opposite ends of the cells 4, and capable of producing a magnetic field oriented parallel to the axes of the cells 4 (as indicated by arrow B in FIG. 1). The anode 3, cathode 5 and magnets 7 define the one or more Penning cells.

During operation, when an electric potential difference (voltage) (typically from 3 to 9 kV) between the anode 3 and the cathode 5 is applied, an intense electric field is generated between the cells 4 of the anode 3 and the cathode 5, this resulting in the emission of electrons from the cathode 5. The electric field, combined with the magnetic field generated by the magnets 7, makes it possible to trap, within the cells 4, the electrons emitted by the cathode 5, thereby creating an electron plasma that is used to ionize the gas molecules present within the environment to be evacuated.

In particular, when the gas molecules enter the cells 4, the plasma electrons collide with these molecules, thereby ionizing them. Because of the electric field, the positive ions resulting from the ionization are attracted towards the cathode 5, leaving the corresponding electrons, left within the cells 4, available for further ionization of the other gas molecules. In this respect, the presence of the magnets 7 for generating the magnetic field allows imparting helical trajectories to electrons, thereby increasing the length of the paths of such electrons between cathode 5 and the anode 3 and, therefore, the possibility of collision and corresponding ionization of the gas molecules present within the cells 4.

Positive ions, meanwhile, reach the cathode 5 and collide with the surface of the cathode 5. The collision of positive ions with the titanium plates 5a and 5b of the cathode 5 causes the phenomenon of sputtering, i.e., the emission of titanium atoms from the cathode 5. The atoms, by covering the inner surfaces of the ion pump 1, create an active titanium film which chemically traps the gas molecules. This mechanism is referred to as pumping at the anode or getter pumping.

As is known, ion pumps are commonly used in ultra-high vacuum (UHV) systems, because they can reach pressures lower than 10⁻¹¹ mbar. Unlike other UHV pumps or conventional mechanical pumps, ion pumps do not have any moving parts and do not require oil or other lubricants. For this reason, ion pumps do not risk contaminating the environments in which they operate, require little maintenance and do not generate vibrations, whereby they constitute an ideal solution for all those applications and production processes that require a clean environment and high-precision control, in both research and industry.

Furthermore, ion pumps are closed pumps, they do not have any foreline. In fact, an ion pump keeps inside all the pumped gas. Therefore, whatever is pumped by an ion pump will remain in it. This avoids the risk of venting the system to which the ion pump is connected. In addition, an ion pump does not require a backing pump during operation, but only at start-up since the ion pump cannot be started at atmospheric pressure.

However, ion pumps are not free from drawbacks. In fact, it should be considered that in ion pumps, a substantially linear relationship exists between pressure and electric current, which means that as the pressure inside the ion pump decreases, the electric current between the anode and the cathode also decreases. Moreover, to increase the performance of an ion pump at different operating pressures, it is preferable to supply such ion pump with different electric potentials. More specifically, to increase the performance of an ion pump at low operating pressures, it is preferable to supply such ion pump with a lower potential (e.g., 3 kV), which leads to correspondingly having a very low electric current between the anode and the cathode. When the electric current level is below the minimum reading value of the reading scale on the device that powers the ion pump, it can be difficult to tell whether the ion pump is operating at low pressure or has switched off accidentally, which means that the ion pump is not pumping any longer even if a voltage difference is still being applied between the pump electrodes (i.e., even if the ion pump is turned on).

Indeed, when the ion pump reaches very low-pressure conditions, there are not enough residual gas molecules to be ionized, thus resulting in the generation of further free electrons. As a result, the electron plasma is switched off and the ion pump stops pumping, despite the voltage difference applied between the pump electrodes (the pump anode and the pump cathode). This condition might occur because the ion pump has worked correctly and has been reaching its intrinsic limit pressure value, but it is in any case disadvantageous for the user. Indeed, if the pressure subsequently rises again (due to either internal or external factors), the ion pump does not immediately start pumping again autonomously. Instead, a pressure rise of several orders of magnitude takes place before the electron plasma is triggered again and the pumping action resumes. By way of example, if an ion pump accidentally switches off when the pressure reaches 10⁻¹² mbar, the pumping action could not autonomously resume until the pressure rises to 10⁻⁸ mbar. Therefore, if the ion pump accidentally switches off and no corrective action is taken, the user has to deal with a pressure much higher than expected when the ion pump autonomously resumes pumping.

A similar scenario might occur when the ion pump is started at very low-pressure conditions.

For the foregoing reasons, there is a need for the user to be aware whether the ion pump is still pumping at very low-pressure conditions or it is no longer pumping. However, if the corresponding current value is below the minimum value of the reading scale, electric current measurement cannot be used for ascertaining whether the ion pump is still pumping or not.

### SUMMARY

In view of the foregoing, there may be a need to provide an ion pump equipped with a monitoring system that makes it possible to determine accurately whether the ion pump is running (is “on”) or is switched off. In particular, there may be a need to provide a monitoring system that can determine the ON/OFF state of the ion pump even when the ion pump is operating under low-pressure conditions. There may also be a need to provide an ion pump equipped with a monitoring system that makes it possible to overcome the drawbacks described above without this leading to a considerable increase in the cost of the ion pump itself. There may also be a need to provide a method for operating an ion pump using the monitoring system to determine the ON/OFF state of the ion pump.

According to the present disclosure, these and other needs may be addressed by an ion pump equipped with a monitoring system as well as by a method for operating such ion pump as disclosed herein.

The ion pump according to the present disclosure comprises, in a known manner, at least one anode and at least one cathode between which an electric potential difference (voltage) is applied. The ion pump is capable of taking on or assuming an ON state in which the electric potential difference applied between the at least one anode and the at least one cathode, in combination with the magnetic field in which the ion pump is immersed, generates an electron plasma. The ion pump is capable of taking on or assuming an OFF state in which no electron plasma is generated despite the electric potential difference applied between the electrodes.

In the ON state, the presence of the electron plasma causes an increase in temperature inside the ion pump. In the OFF state, even if an electric potential difference is applied between the at least one anode and the at least one cathode, there is no electron plasma, so that the temperature inside the ion pump is substantially the same as when the ion pump is turned off (i.e., with no electric potential difference between the electrodes). In other words, the temperature inside the ion pump in the ON state is higher than the temperature inside the ion pump in the OFF state.

Accordingly, the ion pump according to the present disclosure comprises a monitoring system suitable for detecting the temperature inside the ion pump. In fact, by measuring the temperature change inside the ion pump (hereinafter referred to as “internal temperature”), it is possible to determine accurately whether the ion pump is in the ON state or in the OFF state.

Advantageously, the monitoring system according to the present disclosure allows the ON or OFF state of the ion pump to be determined even in conditions of extremely low electric current, lower than the detectability threshold of the commonly used state-of-the-art reading scales, thereby making the monitoring system particularly suitable also for ion pumps operating at low pressure (and thus at low current).

In an embodiment, the monitoring system measures a temperature difference between the internal temperature and the temperature measured at a point outside the ion pump, hereinafter referred to as “external temperature”. In a further embodiment, the monitoring system comprises at least one temperature sensor, located inside the ion pump and arranged to detect the internal temperature of the ion pump. In a further embodiment, the monitoring system comprises at least one (first) temperature sensor, located inside the ion pump and arranged to detect the internal temperature of the ion pump, at least one further (second) temperature sensor arranged to detect an external temperature at a point outside the ion pump, and a processing unit for calculating the temperature difference between the internal temperature and the external temperature.

When the ion pump is in the OFF state, the internal temperature of the ion pump tends to approximate the external temperature and therefore the temperature difference is substantially null. When, instead, the ion pump is in the ON state, the internal temperature increases and the external temperature remains more or less constant, and therefore the temperature difference increases.

The at least one temperature sensor can be, for example, a thermocouple. However, it will be clear to the person skilled in the art that any temperature sensor suitable for measuring the temperature inside the ion pump can be used, e.g., a Pt100 probe.

It should be noted that, generally, ion pumps comprising systems suitable for monitoring the trend of the internal temperature are already known from the state of the art.

For example, document CN 210575823 U (the entire contents of which are incorporated herein by reference) describes an ion pump equipped with a temperature sensor that detects the temperature present inside the ion pump and transmits the measured values to a control device in real time. However, in this document, the purpose of monitoring the temperature is to limit changes in the internal temperature: when the internal temperature detected by the sensor exceeds a certain threshold level, the control device activates a cooling system to bring the temperature back to an ideal operating range.

The increase in temperature, indeed, being caused by the electron plasma, indicates that a percentage of the energy supplied to the ion pump in the form of electric power supply gets wasted for heat production. Therefore, the temperature changes occurring inside an ion pump are conventionally known to be considered as a negative effect that one has always tried to mitigate so as not to jeopardize the operating efficiency of the ion pump.

Analogously, document U.S. Pat. No. 3,361,340 (the entire contents of which are incorporated herein by reference) describes an ion pump equipped with a temperature sensing device for monitoring the temperature in the ion pump which results from power dissipation within the ion pump. As in the above-cited document CN 210575823 U, also in this document the purpose of monitoring the temperature is to interrupt the supply of power to the ion pump (i.e., to turn off the ion pump) each time its temperature approaches a maximum upper temperature limit for the ion pump so that the ion pump cools down before power is supplied again to the ion pump. In this case, too, the temperature rise occurring inside an ion pump is considered as a negative effect leading to the risk of excessive heating of the various parts of the ion pump occurring and resulting in melted electrodes and damage to other internal parts of the ion pump.

In this connection, document US 2022/328294 A1 (the entire contents of which are incorporated herein by reference) describes a method of feeding the ion pump that makes it possible, during switching-on of the ion pump, to limit the formation of intense electron plasmas so as to reduce the amount of energy wasted in the form of heat upon starting of the ion pump itself.

Conversely, according to the present disclosure, the change in temperature is considered not as a phenomenon to be prevented or at least reduced, but rather as a phenomenon to be exploited for accurately determining the ON or OFF state of the ion pump. In addition, according to the present disclosure, it is not provided to turn off the ion pump. Instead, the ion pump is always turned on, which means that an electric potential difference is always applied between the pump electrodes (the at least one anode and the at least one cathode) and, under this condition, the ON (pumping) or OFF (not pumping) state of the ion pump is determined.

In case of application to a low-pressure ion pump, the monitoring system according to the present disclosure is particularly effective because the electron plasma generated by ion pumps of this type does not lead to a temperature increase that would impair the performance thereof.

According to another aspect of the present disclosure, a method of operating an ion pump is provided which, by the monitoring system described above, makes it possible to determine whether the ion pump is in the ON state or in the OFF state. The method of operating an ion pump comprises the steps of:
providing a monitoring system as described above;
in the absence of an electric potential difference between the at least one anode and the at least one cathode, measuring, by the monitoring system, a first internal temperature of the ion pump and/or a first temperature difference between the first internal temperature and the temperature outside the ion pump; at this step, an internal temperature is expected to be substantially constant and equal to the external temperature (also substantially constant) with a resulting temperature difference that is substantially null;
in the presence of an electric potential difference between the at least one anode and the at least one cathode, measuring, by the monitoring system, a second internal temperature of the ion pump and/or a second temperature difference between the second internal temperature and the temperature outside the ion pump;
based on the measurements of temperature and/or temperature difference, assessing the ON or OFF state of the ion pump according to the following criterion:
if the second internal temperature is equal to the first internal temperature or if the first temperature difference is equal to the second temperature difference, detecting (or determining) that the ion pump is in the OFF state;
if the second internal temperature is higher than the first internal temperature or if the second temperature difference is higher than the first temperature difference, detecting (or determining) that the ion pump is in the ON state.

According to a further aspect of the present disclosure, the ion pump may comprise a restart system. As described above, it is essential for the user to be aware, even at very low-pressure and current conditions, whether the ion pump is still pumping or has switched off, so that in the latter case the user can take corrective actions. In the event that the monitoring system described herein detects that the ion pump is in the OFF state, the restart system generates an electric discharge within the ion pump, thereby increasing the probability of restart of the ion pump itself, i.e., increasing the probability of restoring the ON state. The restart system comprises at least one electron emitter, arranged inside the ion pump and capable of generating an electric discharge to cause switching-on of the ion pump (i.e., generation of electron plasma within the ion pump).

In an embodiment, the at least one electron emitter is located near the at least one cathode so as to maximize the probability of generating the electric discharge, while simultaneously reducing the time required to achieve the switching-on.

In this case, too, the restart system is particularly advantageous when applied in a low-pressure ion pump. Indeed, in low-pressure ion pumps, the likelihood of spontaneous generation of an electric discharge capable of causing switching-on of the ion pump is very low and numerous attempts are often necessary before a restart is obtained, this resulting in a lengthening of non-productive time.

According to this further aspect of the present disclosure, a method of operating an ion pump is also provided comprising the steps of:
providing a restart system as described above;
monitoring the ON/OFF state of the ion pump;
if it is detected that the ion pump is in the OFF state, activating the restart system to generate an electric discharge within the ion pump.

### BRIEF DESCRIPTION OF THE DRAWINGS

Further features and advantages of the present disclosure will become more evident from the following detailed description of embodiments of the present disclosure, which is given by way of non-limiting examples with reference to the accompanying drawings.

FIG. 1 shows an ion pump of known type.

FIG. 2a shows a sectional view of a portion of the ion pump according to an embodiment of the present disclosure.

FIG. 2b shows a sectional view of a portion of the ion pump according to a variant embodiment of the present disclosure.

FIG. 3 shows a diagram of the trend of the electric current present in the ion pump of FIGS. 2a and 2b and the pressure present in the ion pump.

FIG. 4 shows a diagram of the trend of the internal temperature of the ion pump of FIGS. 2a and 2b as a function of time.

FIG. 5 shows a schematic view of an ion pumping system according to an embodiment of the present disclosure.

### DETAILED DESCRIPTION

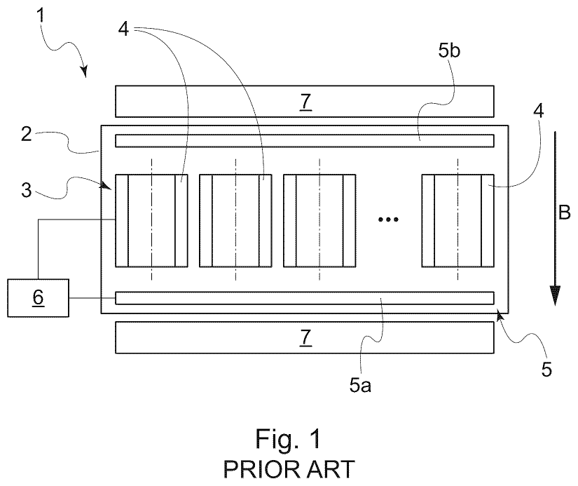

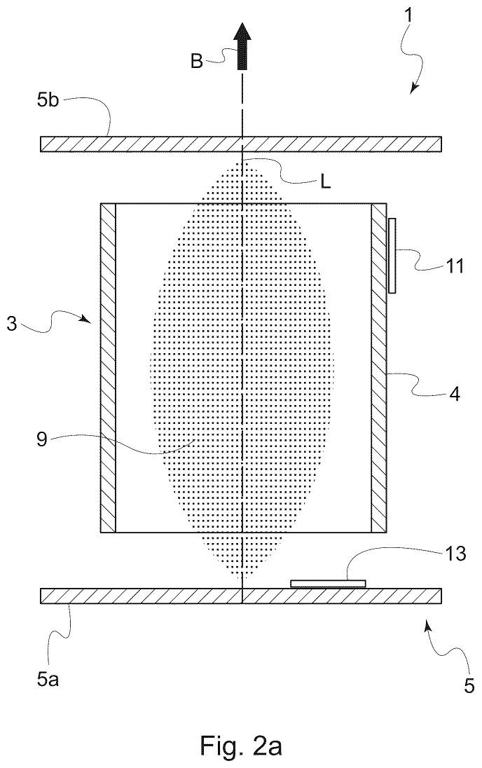

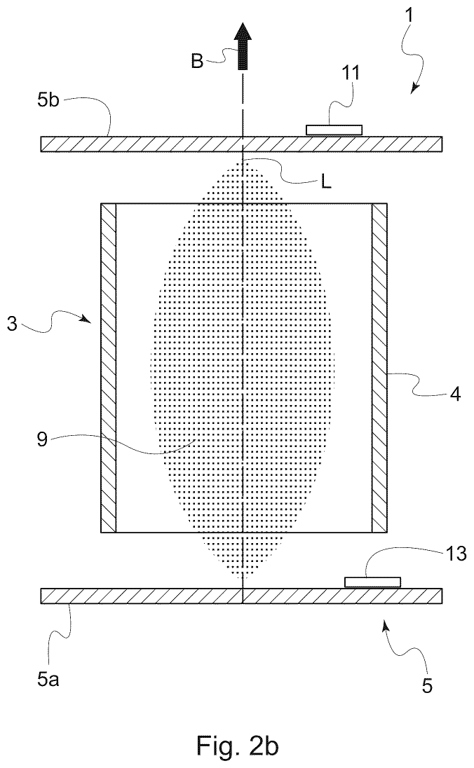

FIGS. 2a and 2b show a representation of a portion of an ion pump 1 according to the present disclosure. The general structure of the ion pump 1 according to the present disclosure is substantially identical to the one of the conventional ion pump 1 shown in FIG. 1, and for this reason the same reference numerals as those used in FIG. 1 will be used to indicate identical or equivalent components. Similarly to conventional ion pumps, the ion pump 1 according to the present disclosure comprises:
a vacuum casing 2 (FIG. 1);
at least one anode 3 disposed (positioned) in the vacuum casing 2 and consisting of a plurality of hollow cylindrical pumping cells 4 (for the sake of simplicity, the longitudinal section of only one cell 4 has been shown in FIGS. 2a and 2b), each pumping cell 4 arranged (or extending) along a longitudinal cell axis L between a first axial side of the pumping cell 4 and a second axial side of the pumping cell 4;
at least one cathode 5, consisting of at least two cathode plates, namely a first cathode plate 5a and a second cathode plate 5b, where the first cathode plate 5a is disposed (positioned) near the first axial sides of the pumping cells 4 and the second cathode plate 5b is disposed (positioned) near the second axial sides of the pumping cells 4;
a device (e.g., voltage source, or potential difference supply) 6 (FIG. 1) configured to apply an electric potential difference (voltage) between the at least one anode 3 and the at least one cathode 5; and
at least two magnets 7 (FIG. 1) disposed (positioned) outside the vacuum casing 2, where a first magnet 7 of the at least two magnets 7 is disposed on the same side of the pumping cells 4 as the first cathode plate 5a and a second magnet 7 of the at least two magnets 7 is disposed on the same side of the pumping cells 4 as the second cathode plate 5b, and the magnets 7 are configured (positioned, oriented, etc.) to generate a magnetic field oriented parallel to the longitudinal cell axes L of the respective pumping cells 4.

The at least two cathode plates 5a, 5b of the cathode 5 are located at the opposite ends of the pumping cells 4 of the anode 3 and are substantially perpendicular to the longitudinal cell axes L of the pumping cells 4. The pumping cells 4 and the cathode plates 5a, 5b are immersed in the magnetic field, the direction of which, represented by arrow B in FIGS. 2a and 2b, is substantially parallel to the longitudinal cell axes L.

When the ion pump 1 is turned off, i.e., when no electric potential difference is applied between the pump electrodes (the at least one anode 3 and the at least one cathode 5), the internal temperature, i.e., the temperature present inside the ion pump 1, is at its minimum value and is substantially equal to the external temperature, i.e., the temperature measured at a point (referred to as “cold point” outside the ion pump 1. When the ion pump 1 is turned on, between the at least one anode 3 and the at least one cathode 5 there is applied an electric potential difference. In the ON state, this electric potential difference applied between the at least one anode 3 and the at least one cathode 5 results in the generation of an electric current within the ion pump 1.

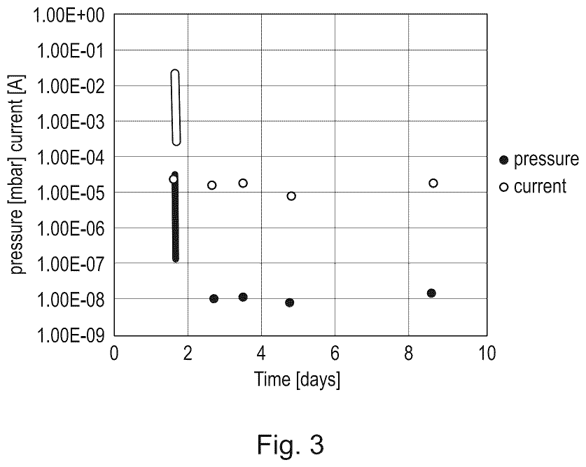

As can be seen from the chart shown in FIG. 3, the electric current, after increasing almost instantaneously upon starting the ion pump 1, approaches an almost constant level.

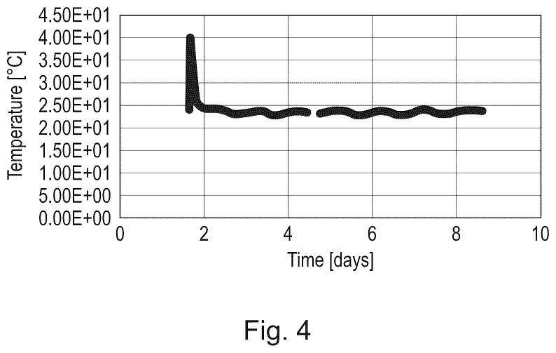

The electric potential difference between the at least one anode 3 and the at least one cathode 5, in combination with the presence of the magnetic field, allows creating an electron plasma 9, imaginarily illustrated in FIGS. 2a and 2b, which in turn causes a sudden change in the pressure inside the ion pump 1 (FIG. 3) and a quick increase in the internal temperature (FIG. 4). Therefore, in the presence of the electron plasma 9, the internal temperature in the ON state increases. In the OFF state, despite an electric potential difference being applied between the at least one anode 3 and the at least one cathode 5, no electric current within the ion pump 1 is generated and no electron plasma is generated. Therefore, no increase in the internal temperature takes place. In other words, in the OFF state, even if the ion pump 1 is turned on (i.e., an electric potential difference is applied between the pump electrodes), the internal temperature is substantially the same as when the ion pump 1 is turned off. In conclusion, the internal temperature in the ON state is higher than the internal temperature in the OFF state.

As the external temperature remains almost constant and is unaffected by the presence or absence of plasma within the ion pump 1, the internal temperature in the ON state is also higher than the external temperature, while the internal temperature in the OFF state is substantially the same as the external temperature.

Furthermore, when comparing the graphs shown in FIG. 3 and FIG. 4, it can be seen that—as long as the ion pump 1 is in the ON state—under normal operating conditions the internal temperature follows a trend proportional to that of the current and the pressure. Therefore, the internal temperature of the ion pump 1, like the current and pressure, is an index of the operational state—in particular of the ON state or OFF state—of the ion pump 1.

In this regard, to determine whether the ion pump 1 is in the ON or the OFF state, the ion pump 1 comprises, according to the present disclosure, a monitoring system suitable for monitoring the internal temperature. Thanks to this monitoring system it is possible to determine whether the ion pump 1 is running and evacuating the gas molecules or has switched off accidentally (i.e., it is no longer running and evacuating the gas molecules even if it is turned on and an electric potential difference is applied between the pump electrodes), an event that may occur quite frequently, especially with low-pressure ion pumps involving a very low electric current.

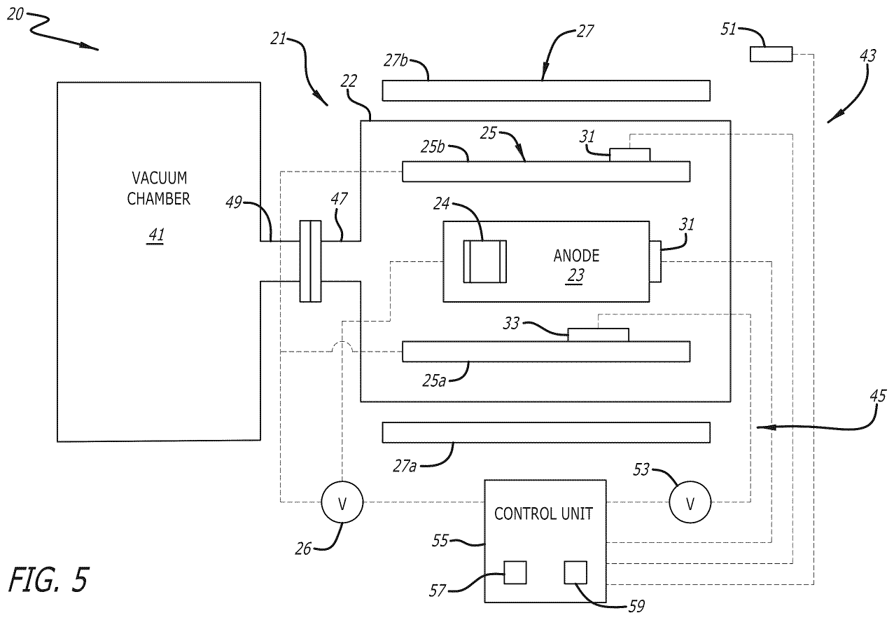

In particular, the monitoring system comprises a first temperature sensor 11 located within the ion pump 1 and configured to measure (and suitable for measuring) the internal temperature. The first temperature sensor 11 may be arranged, for instance, on one of the cells 4 of the anode 3 (see FIG. 2a) or on one of the plates 5b of the cathode 5 (see FIG. 2b). The monitoring system may further comprise a second temperature sensor (not shown, but see FIG. 5) configured to measure (and suitable for measuring) the external temperature, as well as a processing unit (not shown, but see FIG. 5) configured to calculate the temperature difference between the internal temperature and the external temperature.

When the ion pump 1 is in the OFF state, even if the ion pump 1 is turned on, the internal temperature is close to the external temperature and therefore the temperature difference is close to the null value. On the other hand, when the ion pump 1 is in the ON state, the internal temperature is higher than the external temperature and therefore the temperature difference is higher than zero. In conclusion, the temperature difference measured in the ON state is higher or greater than the temperature difference measured in the OFF state.

Alternatively, the monitoring system may include only the first temperature sensor 11 that measures the change in internal temperature depending on whether the ion pump 1 is in the OFF state or in the ON state, and vice versa, without considering the external temperature.

To determine the values of the internal temperature shown in FIG. 4, a thermocouple was used as a first temperature sensor. However, any other type of sensor suitable for measuring the internal temperature could be used, e.g., a Pt100 probe.

Furthermore, the monitoring system might comprise two or more first temperature sensors 11 configured to measure the internal temperature of the ion pump 1 at different locations. For example, the two or more first temperature sensors 11 may be arranged (or located, or positioned) within different cells 4 of the anode 3, or in the gaps between the cells 4, or on one of the cathode plates 5a, 5b at different cells 4 of the anode 3.

According to another aspect of the present disclosure, a method of operating an ion pump 1 is provided which, by the monitoring system described above, makes it possible to determine whether the ion pump 1 is in the ON state or in the OFF state. The monitoring method comprises the steps of:
providing a monitoring system as described above;
in the absence of an electric potential difference between the at least one anode 3 and the at least one cathode 5 (i.e., with the ion pump 1 turned off), measuring, by the monitoring system, a first internal temperature of the ion pump 1 and/or a first temperature difference between the first internal temperature and the temperature outside the ion pump 1 (external temperature);
in the presence of an electric potential difference between the at least one anode 3 and the at least one cathode 5 (i.e. with the ion pump 1 turned on), measuring, by the monitoring system, a second internal temperature of the ion pump 1 and/or a second temperature difference between the second internal temperature and the temperature outside the ion pump 1 (external temperature);
based on the measurements of temperature and/or temperature difference, assessing the ON or OFF state of the ion pump 1 according to the following criterion:
if the second internal temperature is equal to the first internal temperature or if the first temperature difference is equal to the second temperature difference, detecting (or determining) that the ion pump 1 is in the OFF state;
if the second internal temperature is higher than the first internal temperature or if the second temperature difference is higher than the first temperature difference, detecting (or determining) that the ion pump 1 is in the ON state.

According to an embodiment of the present disclosure, a restart system can also be provided within the ion pump 1. In the event that the ion pump 1 is in the OFF state and is to be brought back to the ON state without waiting for the pressure to rise until the ion pump 1 autonomously resumes pumping, it is possible to resort to the restart system, which generates an electric discharge in order to increase the probability of restoring the ON state. The restart system comprises at least one electron emitter 13, arranged inside the ion pump 1, such as at one of the plates 5a of the at least one cathode 5 of the ion pump 1, to further increase the probabilities of generation of the electric discharge.

According to this embodiment of the present disclosure, the method of operating the ion pump 1 further comprises the steps of:
providing a restart system as described above;
if it is detected (or determined) that the ion pump 1 is in the OFF state, activating the restart system to generate an electric discharge within the ion pump 1.

It should be noted that it is also possible to provide that the restart system reacts independently of the monitoring system described above and is activated in the event that the OFF state of the ion pump 1 is detected in another manner and with other means.

FIG. 5 shows a schematic view of a vacuum pumping system 20 according to the present disclosure. The vacuum pumping system 20 includes an ion pump 21 and a vacuum chamber 41. The ion pump 21 may be configured, for example, according to any of the embodiments disclosed herein. Accordingly, in the illustrated example, the ion pump 21 includes a vacuum casing (pump casing) 22, at least one anode (assembly) 23, at least one cathode (assembly) 25, a (first) voltage source (potential difference source or supply) 26, at least one magnet (assembly) 27, a temperature monitoring system 43, and a restart system 45, as described herein.

The ion pump 21 fluidly communicates the vacuum chamber 41 via a pump inlet 47 of the ion pump 21 coupled to a port 49 of the vacuum chamber 41, whereby gas molecules flow from the interior of the vacuum chamber 41 into the interior of the ion pump 21 (i.e., the vacuum casing 22). Fluid flow through the pump inlet 47 and/or the port 49 may be controlled by one or more fluidic valves (not shown) of any appropriate type if desired or needed. The vacuum chamber 41 may be any enclosed space to be evacuated by operation of the ion pump 21 and may be part of any apparatus or system that requires such evacuated space.

The anode 23 may include one or more hollow, cylindrical pumping cells (anode cells) 24 as described herein. The cathode 25 may include one or more cathode plates, for example, at least two cathode plates 25a, 25b, disposed (or positioned, arranged, mounted) on opposite sides of the anode 23, in particular on opposite open sides of the pumping cell(s) 24, as described herein. The (first) voltage source 26 may be any electrical circuitry or hardware configured to apply a controllable electric potential difference between the anode 23 and the cathode 25, as described herein. The circuitry associated with the anode 23, cathode 25, and (first) voltage source 26 may include one or more electrical grounds (e.g., grounding points, terminals, planes, etc.) as appropriate and as appreciated by the skilled artisan. The magnet 27 may include two or more magnets, for example, at least two magnets 27a, 27b disposed (or positioned, arranged, mounted) at (on or near) the respective outer sides of the cathode plates 25a, 25b, as described herein. In the present context, the term “outer side” is relative to the anode 23. That is, the outer side of each magnet 27a, 27b is the side that faces away from the corresponding side of the anode 23. In the illustrated example, the magnets 27a, 27b are located outside the vacuum (pump) housing 22.

The temperature monitoring system 43 is configured to monitor the internal temperature (the temperature measured inside the ion pump 21, in particular in the interior of the vacuum housing 22) or both the internal temperature and the external temperature (the temperature measured outside the ion pump 21, in particular in the ambient space outside the vacuum housing 22), as described above. Accordingly, in the illustrated example, the temperature monitoring system 43 includes one or more first (internal) temperature sensors 31 and one or more second (external) temperature sensors 51. The first temperature sensor(s) 31 may be disposed (or positioned, arranged, mounted) at any appropriate location inside the vacuum housing 22. In the illustrated example, one or more first temperature sensors 31 may be disposed at the anode 23 (e.g., at one or more of the pumping cells 24—that is, in one or more of the pumping cells 24, on one or more of the pumping cells 24, near one or more of the pumping cells 24, between two or more pairs of adjacent pumping cells 24, etc.). Alternatively or additionally, the first temperature sensor(s) 31 may be disposed (or positioned, arranged, mounted) at the cathode 25 (e.g., on or near one or more of the cathode plate(s) 25a, 25b). The second temperature sensor(s) 51 may be disposed (or positioned, arranged, mounted) at one or more appropriate locations (or “cold point(s)”) outside the ion pump 21 (in particular, outside the vacuum housing 22).

In the event that the ion pump 21 is in the OFF state and is to be brought back to the ON state without waiting for the pressure to rise until the ion pump 21 autonomously resumes pumping, the restart system 45 is configured to generate an electric discharge inside the ion pump 21 to thereby increase the probability of restoring the ON state, as described herein. For this purpose, the restart system includes at least one electron emitter 33 disposed (or positioned, arranged, mounted) inside the ion pump 21 (in particular, in the interior of the vacuum housing 22) and a (second) voltage source 53. The electron emitter(s) 33 is/are configured to generate the electric discharge in response to being activated (powered) by the (second) voltage source 53. In the illustrated example, the electron emitter 33, or at least one of the electron emitters 33 provided, is disposed at or on (e.g., mounted near or to) the cathode 25, such as one of the cathode plates 25a, 25b. The (second) voltage source 53 is configured to apply a voltage potential to the electron emitter(s) 33 at a magnitude effective for causing electron emission by an appropriate mechanism as appreciated by the skilled artisan. The (second) voltage source 53 may be configured to apply a voltage (electric potential difference) between the electron emitter(s) 33 and another part of the associated circuitry (e.g., electrode, electrical ground, etc.) as appreciated by the skilled artisan.

The ion pump 21 may also include a controller (or system controller, control unit, computing device, etc.) 55. The controller 55 may schematically represent one or more modules (or units, components, etc.) configured (or programmed) for controlling, monitoring and/or timing various functional aspects of the vacuum pumping system 20 including, for example, the operations of one or more components of (or communicating with) the ion pump 21, as described herein. In the present context, the term “control” denotes wired or wired communication with a given, controlled/controllable component. Depending on the type of component, such “control” may entail monitoring the operation of the component, timing the operation of the component, adjusting the operation of the component, sending control signals to the component, receiving output signals from the component (e.g., measurement or detection signals), and/or otherwise communicating with the component, as appreciated by the skilled artisan. All or part of the controller 55 (such as may be disposed in an electronics box) may be located directly at the ion pump 21 or separately (or remotely) from the ion pump 21.

For example, the controller 55 may be configured to control, monitor, and/or otherwise communicate with the (first) voltage source 26 and the (second) voltage source 53 (e.g., by setting, implementing, and/or adjusting magnitudes of voltage potentials applied, controlling the timing of operations of the (first) voltage source 26 and the (second) voltage source 53, etc.). The controller 55 may be configured to interrogate and receive (continuously or during certain time periods of predetermined lengths and at predetermined intervals) measurement (or detection) signals from the first temperature sensor(s) 31 and the second temperature sensor(s) 31, or additionally other types of sensors (e.g., pressure sensor(s)) and process such measurement signals as needed or desired. In particular, in the illustrated example, the controller 55 is configured to calculate the temperature difference between the internal temperature and the external temperature as measured by the first temperature sensor(s) 31 and the second temperature sensor(s) 31, respectively. The controller 55 may be configured to control, monitor, and/or otherwise communicate with one or more pressure sensors (e.g., pressure sensors configured to measure the pressure inside the ion pump 21 and/or the vacuum chamber 41; not specifically shown) and/or one or more fluidic valves (not specifically shown) provided in the vacuum pumping system 20. As such, depending on the embodiment, the controller 55 (or a part or module thereof) may be considered as being part of the temperature monitoring system 43 and/or the restart system 45.

The controller 55 may be configured to control the output (e.g., visual display, audible output, visual and/or audio alarms, wired or wireless communication (e.g., email, text message, etc.), or a combination of two or more of the foregoing, etc.) of user-interpretable indications of measured temperatures, pressure (e.g., vacuum level inside the ion pump 21 and/or vacuum chamber 41), voltage potential levels or settings, and other operational parameters of the vacuum pumping system 20 (in particular, the ion pump 21). The controller 55 may be configured to read and process (e.g., analyze) output signals such as measurement signals (temperature, voltage potential, potential difference, etc.) for purposes of diagnostics and/or data logging. The controller 55 may be configured to control, monitor, and/or otherwise communicate with other controllable or readable devices or components such as, for example, timing controllers, clocks, frequency/waveform generators, logic circuits, etc. The controller 55 may be configured to control or perform one or more of the steps of any of the method implementations disclosed herein. In FIG. 5, the schematically illustrated controller 55 is representative of all such components described in this paragraph that are associated with the controller 55.

For all such purposes, the controller 55 may be in wired or wireless communication with one or more of the components of the vacuum pumping system 20, as depicted by dashed lines in FIG. 5, and may include any suitable combination of hardware, firmware, software, etc., including one or more electronics-based processors 57 and memories 59, as appreciated by persons skilled in the art. For example, the controller 55 may include a non-transitory (or tangible) computer-readable medium that includes non-transitory instructions stored thereon, that when executed on a processor, control or perform one or more of the steps of any of the method implementations disclosed herein. In FIG. 5, the schematically illustrated controller 55 is representative of all such components described in this paragraph that are associated with the controller 55.

One or more modules of the controller 55 may be, or be embodied in, one or more devices located outside or separate from the vacuum pumping system 20, for example, a computer workstation, desktop computer, laptop computer, portable computer, tablet computer, handheld computer, mobile computing device, personal digital assistant (PDA), smartphone, remote server, etc. One or more modules of the controller 55 may communicate with one or more other modules via one or more busses or other types of communication lines or wireless links, as appreciated by persons skilled in the art. In FIG. 5, the schematically illustrated controller 55 is representative of all such components described in this paragraph that are associated with the controller 55.

The processor(s) 57 of the controller 55 may be representative of a main electronic processor providing overall control, and one or more electronic processors configured for dedicated control operations or specific signal processing tasks (e.g., a graphics processing unit or GPU, a digital signal processor or DSP, an application-specific integrated circuit or ASIC, a field-programmable gate array or FPGA, etc.). The memory or memories 59 (e.g., volatile and/or non-volatile types, e.g., RAM and/or ROM) may be configured to store data and/or software. Stored data may be organized, for example, in one or more databases or look-up tables. The controller 55 may also include one or more device drivers for controlling one or more types of user interface devices and providing an interface between the user interface devices and components of the controller 55 communicating with the user interface devices. Such user interface devices may include user input devices (e.g., keyboard, keypad, touch screen, mouse, joystick, trackball, and the like) and user output devices (e.g., display screen, printer, visual indicators or alerts, audible indicators or alerts, and the like). In various implementations, the controller 55 may be considered as including one or more of the user input devices and/or user output devices, or at least as communicating with them. In FIG. 5, the schematically illustrated controller 55 is representative of all such components described in this paragraph that are associated with the controller 55.

In some implementations, the controller 55 may also include one or more types of computer programs or software contained in the memory (or memories) 59 and/or on one or more types of non-transitory (or tangible) computer-readable media. One or more devices of the controller 55 may be configured to receive and read (and optionally write to) the memory (or memories) 59 and/or computer-readable media. The computer programs or software may contain non-transitory instructions (e.g., logic instructions) for controlling or performing various operations of the vacuum pumping system 20, such as the operations of the various devices described herein. The computer programs or software may include system software and application software. System software may include an operating system (e.g., a Microsoft Windows® operating system) for controlling and managing various functions of the controller 55, including interaction between hardware and application software. In particular, the operating system may provide a graphical user interface (GUI) displayable via a user output device of the controller 55, and with which a user may interact with the use of a user input device of the controller 55. Application software may include software configured to control or execute various operations of the vacuum pumping system 20, and/or some or all of the steps of any of the methods disclosed herein. In FIG. 5, the schematically illustrated controller 55 is representative of all such components described in this paragraph that are associated with the controller 55.

The controller 55 may also include an ion pump controller (or control module) configured to control the operation of one or more components of the ion pump 21 (e.g., on/off states, power supplied, etc.). The controller 55 may also include one or more sensor interfaces configured to receive and process feedback (e.g., measurement) signals received from one or more sensors/meters/data loggers provided with the ion pump 21, such as the first temperature sensor(s) 31, second temperature sensor(s) 31, first voltage source 26, second voltage source 53, pressure sensors, actively controlled or monitored fluidic valves, etc., as described above. For example, the sensor interfaces may be embodied in different pieces of firmware or other electronic circuitry that are part of a microcontroller of the controller 55. The sensor interfaces may communicate with the ion pump controller and other components of the controller 55 as needed to provide effective control of various operations of the ion pump 21 and/or the performance of any of the methods described herein. The firmware or other electronic circuitry embodying the ion pump controller also may be provided with the same microcontroller that includes the sensor interfaces, or the firmware or other electronic circuitry may be provided with separate hardware of the controller 55. The controller 55 may also include a data acquisition module (or DAQ) configured to further condition or process the signals received by the sensor interface(s) as needed for preparing data to be analyzed by the controller 55. In FIG. 5, the schematically illustrated controller 55 is representative of all such components described in this paragraph that are associated with the controller 55.

It will be evident to the person skilled in the art that the embodiments described above in detail should in no way be understood in a limiting sense, and that numerous modifications and variants are possible without thereby departing from the scope of protection as defined by the appended claims.

For instance, even if in the above disclosure reference has been made to an ion pump having a so-called “diode configuration” in which the cathode is grounded and a positive electric potential is applied to the anode, the present disclosure may also be applied to an ion pump having a so-called “triode configuration”, in which the anode and the pump casing are grounded and a negative electric potential is applied to the anode.

It will be understood that one or more of the processes, sub-processes, and process steps described herein may be performed by hardware, firmware, software, or a combination of two or more of the foregoing, on one or more electronic or digitally-controlled devices. The software may reside in a software memory (which may be represented, e.g., by the memory 59 schematically depicted in FIG. 5) in a suitable electronic processing component or system such as, for example, the controller 55 schematically depicted in FIG. 5. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module (which may be represented, e.g., by the processor 57 schematically depicted in FIG. 5). The processing module may include, for example, one or more microprocessors, general purpose processors, combinations of processors, digital signal processors (DSPs), application specific integrated circuits (ASICs), field-programmable gate array (FPGAs), etc. Further, the schematic diagrams in the drawing figures describe a logical division of functions having physical (hardware and/or software) implementations that are not limited by architecture or the physical layout of the functions. The examples of systems, apparatuses, devices, components, modules, or sub-modules described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the controller 55 schematically depicted in FIG. 5), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system (or apparatus, or device). A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, apparatus, device, component, module, or sub-module to a second system, apparatus, device, component, module, or sub-module along a signal path between the first and second systems, apparatuses, devices, components, modules, or sub-modules. The signal paths may include physical, electrical, magnetic, electromagnetic, electrochemical, optical, wired, or wireless connections. The signal paths may also include one or more additional systems, apparatuses, devices, components, modules, or sub-modules between the first and second systems, apparatuses, devices, components, modules, or sub-modules.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic, or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

1. An ion pump, comprising:
at least one anode;
at least one cathode;
a voltage source configured to apply an electric potential difference between the at least one anode and the at least one cathode;
at least two magnets configured to immerse the at least one anode and the at least one cathode in a magnetic field,
wherein the ion pump is configured to assume an ON state in which the electric potential difference is applied, in combination with the magnetic field, to generate an electron plasma, and an OFF state in which no electron plasma is generated despite the electric potential difference being applied; and
a monitoring system configured to measure an internal temperature inside the ion pump and/or a temperature difference between the internal temperature and an external temperature outside the ion pump, and, based on the measurement of the internal temperature and/or the temperature difference, determine whether the ion pump is in the ON state or the OFF state.

2. The ion pump according to claim 1, wherein the monitoring system comprises one of:
at least one first temperature sensor located inside the ion pump and configured to monitor the internal temperature;
at least one first temperature sensor located inside the ion pump and configured to monitor the internal temperature, and at least one second temperature sensor located outside the ion pump and configured to measure the external temperature.

3. The ion pump according to claim 1, wherein the monitoring system comprises at least one first temperature sensor configured to monitor the internal temperature, and the ion pump comprises at least one of:
the at least one first temperature sensor is arranged at the at least one anode and/or at the at least one cathode;
the at least one anode comprises a plurality of pumping cells, and the at least one first temperature sensor is arranged at one or more of the pumping cells;
the at least one cathode comprises at least two cathode plates arranged at opposite sides of the at least one anode, and the at least one first temperature sensor is arranged at one or more of the at least two cathode plates.

4. The ion pump according to claim 1, wherein the monitoring system comprises at least one first temperature sensor located inside the ion pump and configured to monitor the internal temperature, at least one second temperature sensor located outside the ion pump and configured to measure the external temperature, and a controller configured to calculate the temperature difference.

5. The ion pump according to claim 1, comprising a controller configured to control the voltage source and/or the monitoring system.

6. The ion pump according to claim 1, comprising a restart system configured to generate an electric discharge inside the ion pump when the ion pump is in the OFF state, the restart system comprising at least one electron emitter arranged inside the ion pump and configured to generate the electric discharge.

7. The ion pump according to claim 6, wherein the voltage source configured to apply the electric potential difference between the at least one anode and the at least one cathode is a first voltage source, and the restart system comprises a second voltage source configured to apply an electric potential to the electron emitter effective to generate the electric discharge.

8. The ion pump according to claim 6, comprising one of:
a controller configured to control an operation of the at least one electron emitter;
wherein the voltage source configured to apply the electric potential difference between the at least one anode and the at least one cathode is a first voltage source, the restart system comprises a second voltage source configured to apply an electric potential to the electron emitter effective to generate the electric discharge, and the ion pump comprises a controller configured to control an operation of the second voltage source.

9. The ion pump according to claim 6, wherein the at least one cathode comprises at least two cathode plates, at least one of the at least two cathode plates is arranged at one side of the at least one anode, at least one other of the at least two cathode plates is arranged at another side of the at least one anode opposite to the one side, and the at least one electron emitter is arranged at one or more of the at least two cathode plates.

10. A method for operating an ion pump, the method comprising:
providing the ion pump, wherein:
the ion pump comprises at least one anode, at least one cathode, a voltage source configured to apply an electric potential difference between the at least one anode and the at least one cathode, and at least two magnets configured to immerse the at least one anode and the at least one cathode in a magnetic field; and
the ion pump is configured to assume an ON state in which the electric potential difference is applied, in combination with the magnetic field, to generate an electron plasma, and an OFF state in which no electron plasma is generated despite the electric potential difference being applied;
measuring, by a monitoring system of the ion pump, an internal temperature inside the ion pump and/or a temperature difference between the internal temperature and an external temperature outside the ion pump; and
determining whether the ion pump is in the ON state or the OFF state based on the measuring of the internal temperature and/or the temperature difference.

11. The method according to claim 10, wherein the monitoring and the determining comprise:
in the absence of the electric potential difference between the at least one anode and the at least one cathode, measuring, by the monitoring system, a first temperature inside the ion pump and/or a first temperature difference between the first temperature inside the ion pump and the external temperature;
in the presence of the electric potential difference between the at least one anode and the at least one cathode, measuring, by the monitoring system, a second temperature inside the ion pump and/or a second temperature difference between the second temperature inside the ion pump and the external temperature; and
monitoring the ON or the OFF state of the ion pump according to the following criterion:
if the measured second temperature inside the ion pump is equal to the measured first temperature inside the ion pump and/or if the first temperature difference is equal to the second temperature difference, determining that the ion pump is in the OFF state;
if the measured second temperature inside the ion pump is higher than the measured first temperature inside the ion pump or if the second temperature difference is higher than the first temperature difference, determining that the ion pump is in the ON state.

12. The method according to claim 10, wherein the ion pump comprises one of:
at least one first temperature sensor located inside the ion pump and configured to monitor the internal temperature;
at least one first temperature sensor located inside the ion pump and configured to monitor the internal temperature, and at least one second temperature sensor located outside the ion pump and configured to measure the external temperature.

13. The method according to claim 10, wherein the monitoring system comprises at least one first temperature sensor configured to monitor the internal temperature, and the ion pump comprises at least one of:
the at least one first temperature sensor is arranged at the at least one anode and/or at the at least one cathode;
the at least one anode comprises a plurality of pumping cells, and the at least one first temperature sensor is arranged at one or more of the pumping cells;
the at least one cathode comprises at least two cathode plates arranged at opposite sides of the at least one anode, and the at least one first temperature sensor is arranged at one or more of the at least two cathode plates.

14. The method according to claim 10, wherein the monitoring system comprises at least one first temperature sensor located inside the ion pump and configured to monitor the internal temperature, at least one second temperature sensor located outside the ion pump and configured to measure the external temperature, and a controller configured to calculate the temperature difference.

15. The method according to claim 10, wherein the ion pump comprises a controller configured to control the voltage source and/or the monitoring system.

16. The method according to claim 10, comprising:
wherein the ion pump comprises a restart system configured to generate an electric discharge inside the ion pump when the ion pump is in the OFF state; and
during the monitoring, if it is determined that the ion pump is in the OFF state, activating the restart system to generate the electric discharge.

17. The method according to claim 16, wherein the restart system comprises at least one electron emitter arranged inside the ion pump and configured to generate the electric discharge.

18. The method according to claim 17, wherein the voltage source configured to apply the electric potential difference between the at least one anode and the at least one cathode is a first voltage source, and the restart system comprises a second voltage source configured to apply an electric potential to the electron emitter effective to generate the electric discharge.

19. The method according to claim 17, wherein the ion pump comprises one of:
a controller configured to control an operation of the at least one electron emitter;
wherein the voltage source configured to apply the electric potential difference between the at least one anode and the at least one cathode is a first voltage source, the restart system comprises a second voltage source configured to apply an electric potential to the electron emitter effective to generate the electric discharge, and the ion pump comprises a controller configured to control an operation of the second voltage source.

20. The method according to claim 17, wherein the at least one cathode comprises at least two cathode plates, at least one of the at least two cathode plates is arranged at one side of the at least one anode, at least one other of the at least two cathode plates is arranged at another side of the at least one anode opposite to the one side, and the at least one electron emitter is arranged at one or more of the at least two cathode plates.
